(19) United States
(12) Patent Application Publication
(10) Pub. No.: US 2023/0172796 A1
(43) Pub. Date: Jun. 8, 2023

(54) ELECTRIC MASSAGE CAP

(71) Applicant: Shanghai Sintang Industrial Co.,Ltd., Shanghai (CN)

(72) Inventors: Saihua Chen, Shanghai (CN); Chuankui Du, Shanghai (CN); Jinnian Dong, Shanghai (CN)

(73) Assignee: Shanghai Sintang Industrial Co.,Ltd., Shanghai (CN)

(21) Appl. No.: 17/883,632

(22) Filed: Aug. 9, 2022

(30) Foreign Application Priority Data
Jun. 17, 2022 (CN) 202221535287.4

(51) Int. Cl. A61H 23/02

(52) U.S. Cl. CPC A61H 23/02; A61H 2205/021; A61H 2201/1607

(57) ABSTRACT

The present disclosure is applicable to the technical field of massage apparatuses, and provides an electric massage cap, including a cap body, a liner, a massage unit, a vibration source, a control unit and a battery pack; the liner, the massage unit, and the vibration source are all mounted in the cap body; the massage unit made of an elastic retractable material and shaped like a convex contact is arranged on the liner and is in contact with the head of a user; the vibration source is mounted in the massage unit; vibration energy generated by the vibration source is converted into swing and touch energy through the massage unit to massage the head of the user in a vibrating, stroking and finger-pressing manner; the control unit is connected to the vibration source and battery pack respectively; and the vibration source is controlled to vibrate by control unit.

### TECHNICAL FIELD

The present disclosure belongs to the technical field of massage apparatuses, and particularly relates to an electric massage cap.

### BACKGROUND

Head massage can promote blood circulation in the head, improve the oxygen uptake ability of the brain, and help improve the functions of the cerebral cortex. Head massage has effects of improving the hair quality, preventing hair loss and promoting hair growth. Massage can effectively stimulate the acupuncture points on the head to refresh the mind and eliminate fatigue, and can also relieve tension, anxiety and other emotions, thus reenergizing the brain. Head massage can relax local tense fascia and achieve a purpose of alleviating a headache. There are many acupuncture points on the head, and many main and collateral channels pass through the head. Head massage has many benefits for dredging the channels.

Existing ordinary hats often do not have a massage function. Most of existing head massagers are designed into bulky plastic helmets, which are not convenient to carry around. Such a helmet is not beautiful enough when it is worn due to its large appearance.

### SUMMARY

An embodiment of the present disclosure aims to provide an electric massage cap, and aims at solving the problems that an existing head massager is inconvenient to carry around and is not beautiful enough when it is worn.

The embodiment of the present disclosure is achieved below: An electric massage cap includes:

a cap body, a liner, a massage unit, a vibration source, a control unit and a battery pack, wherein the liner, the massage unit, and the vibration source are all mounted in the cap body; the massage unit made of an elastic retractable material and shaped like a convex contact is arranged on the liner and is in contact with the head of a user; the vibration source is mounted in the massage unit; vibration energy generated by the vibration source is converted into swing and touch energy through the massage unit to massage the head of the user in a vibrating, stroking and finger-pressing manner; the control unit is connected to the vibration source and the battery pack respectively; and the vibration source is controlled to vibrate by the control unit.

In a further technical solution, the electric massage cap includes a plurality of massage units which are distributed on a surface of the liner in a dispersed manner.

In a further technical solution, the massage unit protrudes from a lower surface of the liner and is preferentially in contact with the head.

In a further technical solution, a surface of the massage unit that is in no contact with the head is recessed, and the vibration source is mounted in the recess. The vibration source does not occupy a space between the liner and the cap body since it is arranged in the recess.

In a further technical solution, the massage unit is elastically connected to the liner, so that the massage unit features with an elastic retractility in a vertical direction, and an ability of flexibly swinging around a root by 360 degrees. When the electric massage cap is worn on the head, the massage unit can be adjusted by self retraction according to a clearance between the head and the liner, so as to be in full contact with the head.

In a further technical solution, the cap body is made of a soft material. The electric massage cap is folded and stored by means of preparing the cap body from the soft material.

In a further technical solution, the liner is made of a soft material. The electric massage cap is folded and stored by means of preparing the liner from the soft material.

In a further technical solution, a wire between the control unit and the vibration source is uniformly laid between the liner and the cap body, so that contact between the head and the wire is avoided.

According to the electric massage cap provided in the embodiment of the present disclosure, a user wears the cap body on the head; a battery supplies power to the vibration source through the control unit, and the vibration source can be turned on and controlled to vibrate through the control unit; a surface of the massage unit that is in contact with the head of the user is convex; the vibration source is mounted inside the massage unit, and will not occupy a sandwiching space between the cap body and the liner; and the massage unit can adapt to the outline of the head of a wearer due to its retractable elasticity. A massager is designed to be a cap shape, which increases the beauty of wearing. Meanwhile, the electric massage cap is simple in structure, light in weight, easy to fold and store, and convenient to carry around.

### BRIEF DESCRIPTION OF THE DRAWINGS

FIG. 1 is a schematic diagram of wearing of an electric massage cap provided in an embodiment of the present disclosure;

FIG. 2 is a schematic top view of an electric massage cap provided in an embodiment of the present disclosure;

FIG. 3 is an exploded diagram of an electric massage cap provided in an embodiment of the present disclosure;

FIG. 4 is a bottom view of a liner and a schematic diagram of a massage unit of an electric massage cap provided in an embodiment of the present disclosure.

In the drawings: cap body 1, massage unit 200, vibration source 202, liner 203, control unit 205, button 301, battery pack 401, and battery pack fixing member 402.

### DETAILED DESCRIPTION OF THE EMBODIMENTS

In order to make the objectives, technical solutions and advantages of the present disclosure clearer, the present disclosure is further described in detail below with reference to accompanying drawings and embodiments. It should be understood that the specific embodiments described here are merely to illustrate and explain the present disclosure, and not intended to limit the present disclosure.

Specific implementation of the present disclosure is described in detail below in combination with specific embodiments.

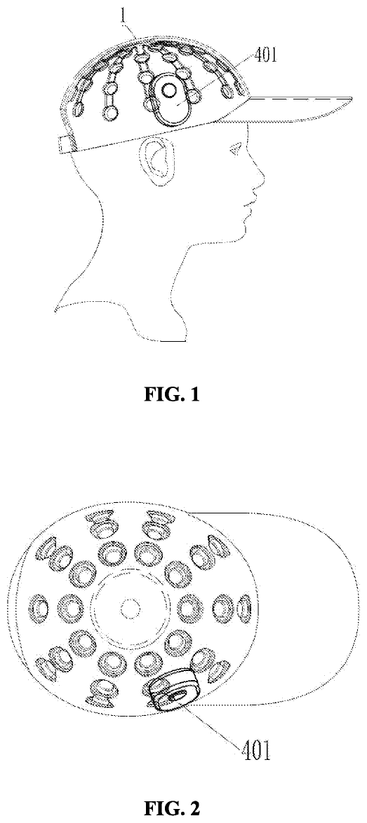

As shown in FIG. 1 to FIG. 4, an electric massage cap provided in one embodiment of the present disclosure is illustrated, including:

a cap body 1, a liner 203, a massage unit 200, a vibration source 202, a control unit 205 and a battery pack 401. The liner 203, the massage unit 200, and the vibration source 202 are all mounted in the cap body 1; the massage unit 200 made of an elastic retractable material and shaped like a convex contact is arranged on the liner 203 and is in contact with the head of a user; the vibration source 202 is mounted in the massage unit 200; vibration generated by the vibration source 202 can be converted into swinging and touching through the massage unit 200 to massage the head of the user in a vibrating, stroking and finger-pressing manner; the control unit 205 is connected to the vibration source 202 and the battery pack 401 respectively; and the vibration source 202 is controlled to vibrate by the control unit 205.

In the embodiment of the present disclosure, a plurality of pits are distributed on a surface of the liner 203 adjacent to the cap body 1 in a dispersed manner; the convex massage units 200 are arranged on a surface opposite to the pits; the vibration sources 202 are mounted inside the pits; the vibration sources 202 are connected to the control unit 205 through wires; one battery pack fixing member 402 used for fixing the battery pack 401 is mounted on an outer side of the cap body 1; the battery pack 401 includes a rechargeable battery, a power management circuit board and a button 301; the battery pack 401 is detachable, so it can be quickly mounted on the battery pack fixing member 402 and quickly removed from the battery pack fixing member 402; a plurality of metal conductive contacts are equipped at mutually connection parts of the battery pack 401 and the battery pack fixing member 402; the battery pack supplies power to the vibration sources 202 through the control unit 205; the control unit 205 is mounted in a central pit at an arc-shaped top of the liner; the vibration sources 202 are connected to the control unit 205 through wires; the control unit 205 is connected to the battery pack fixing member 402 through a wire; the battery pack fixing member 402 is connected to the battery pack 401 through the metal contacts to form an electric loop; the button 301 is mounted on the battery pack 401; the button communicates with the control unit 205 through the metal contacts for connection between the battery pack fixing member 402 and the battery pack 401; and the button 301 is operated to control the start, stop, strength and duration of the vibration of the vibration sources 202. During use, a user wears the cap body 1 on the head; the battery pack 401 supplies power to the vibration sources 202 through the control unit 205, and the vibration sources 202 vibrate; the vibration is conducted to the head of the user through the massage units 200; partial vibration energy of partial vibration is converted into swing and touch energy through the elastic retractility of the massage units 200 to massage the head of the user in a vibrating, stroking and finger-pressing manner; A massager is designed to be a cap shape, which increases the beauty of wearing. Meanwhile, the electric massage cap is simple in structure, light in weight, easy to fold and store, and convenient to carry around.

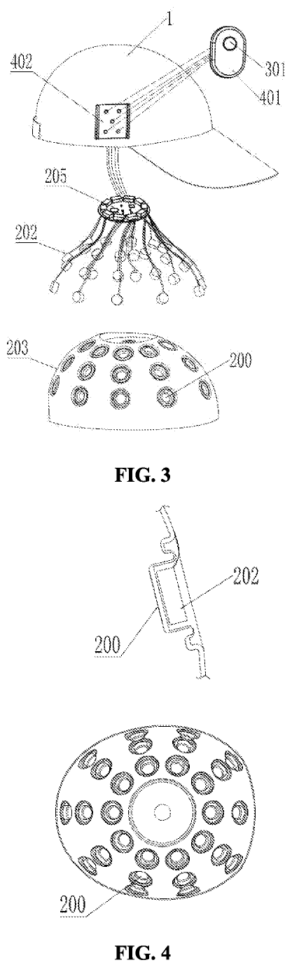

As shown in FIG. 3 and FIG. 4, as a preferable embodiment of the present disclosure, the electric massage cap includes a plurality of massage units 200 which are distributed on a surface of the liner 203 in a dispersed manner.

In the embodiment of the present disclosure, the electric massage cap includes a plurality of massage units 200 which are distributed in a dispersed manner on a side of the liner 203 that is in contact with the head of the user. A head massage effect is achieved by vibration of the plurality of massage units 200 provided with the vibration sources 202. The plurality of massage units 200 are arranged to expand a massage range and enhance the massage effect.

As shown in FIG. 3 and FIG. 4, as a preferable embodiment of the present disclosure, the massage units 200 protrude from a lower surface of the liner 203 and are preferentially in contact with the head.

In the embodiment of the present disclosure, the massage units 200 protrude from the liner. Convex points are elastically connected to the liner 203, so that the massage units have elastic retractility. When the electric massage cap is worn on the head, the massage units 200 can be adjusted by self retraction, so as to be in full contact with the head.

As shown in FIG. 3 and FIG. 4, as a preferable embodiment of the present disclosure, a surface of each massage unit 200 that is in no contact with the head is recessed, and each vibration source 202 is mounted in the recess. The vibration source 202 does not occupy a space between the liner 203 and the cap body 1 since it is arranged in the recess.

In the embodiment of the present disclosure, the massage units 200 are elastically connected to the liner 203, so that the massage units have elastic retractility. When the electric massage cap is worn on the head, the massage units 200 can be adjusted by self retraction, so as to be in full contact with the head.

As shown in FIG. 3, as a preferable embodiment of the present disclosure, the cap body 1 is made of a soft material. The electric massage cap is folded and stored by means of preparing the cap body 1 from the soft material.

In the embodiment of the present disclosure, the cap body 1 preferably uses cloth as a main raw material, which is conductive to the folding and storage of the embodiment of the present disclosure.

As shown in FIG. 3, as a preferable embodiment of the present disclosure, the liner 203 is made of a soft material. The electric massage cap is folded and stored by means of preparing the liner 203 from the soft material.

In the embodiment of the present disclosure, the liner 203 is made of the soft material, which is conductive to the folding and storage of the embodiment of the present disclosure.

As shown in FIG. 3, as a preferable embodiment of the present disclosure, wires between the control unit 205 and the vibration sources 202 are uniformly laid between the liner 203 and the cap body 1, so that contact between the head and the wires is avoided.

In the embodiments of the present disclosure, the liner 203 is mounted in the cap body 1. The wires between the control unit 205 and the vibration sources 202 are uniformly laid between the liner and the cap body, so that contact between the head and the wires is avoided.

According to the electric massage cap provided in the above-mentioned embodiment of the present disclosure, a massager is designed to be a cap shape, which increases the beauty of wearing. Meanwhile, the electric massage cap is simple in structure, light in weight, easy to fold and store, and convenient to carry around.

The above descriptions are only the preferred embodiments of the present utility model, and are not intended to limit the present utility model. Any modifications, equivalent replacements and improvements that are made within the spirit and principle of the present utility model shall fall within the protection scope of the present utility model.

What is claimed is:

1. An electric massage cap, comprising:
a cap body, a liner, a massage unit, a vibration source, a control unit and a battery pack, wherein the liner, the massage unit, and the vibration source are all mounted in the cap body; the massage unit made of an elastic retractable material and shaped like a convex contact is arranged on the liner and is in contact with the head of a user; the vibration source is mounted in the massage unit; vibration energy generated by the vibration source is converted into swing and touch energy through the massage unit to massage the head of the user in a vibrating, stroking and finger-pressing manner; the control unit is connected to the vibration source and the battery pack respectively; and the vibration source is controlled to vibrate by the control unit.

2. The electric massage cap according to claim 1, wherein the electric massage cap comprises a plurality of massage units which are distributed on a surface of the liner in a dispersed manner.

3. The electric massage cap according to claim 1, wherein the massage unit protrudes from a lower surface of the liner and is preferentially in contact with the head.

4. The electric massage cap according to claim 3, wherein a surface of the massage unit that is in no contact with the head is recessed, and the vibration source is mounted in the recess.

5. The electric massage cap according to claim 1, wherein the massage unit is elastically connected to the liner, so that the massage unit features with an elastic retractility in a vertical direction, and an ability of flexibly swinging around a root by 360 degrees.

6. The electric massage cap according to claim 1, wherein the cap body is made of a soft material.

7. The electric massage cap according to claim 1, wherein the liner is made of a soft material.

8. The electric massage cap according to claim 1, wherein a wire between the control unit and the vibration source is uniformly laid between the liner and the cap body, so that contact between the head and the wire is avoided.
